(19) United States
(12) Patent Application Publication
(10) Pub. No.: US 2002/0183085 A1
(43) Pub. Date: Dec. 5, 2002

(54) Method for controlling a multicall in a mobile communications system

(76) Inventor: Jong Man Park, Incheon (KR)

Correspondence Address: BACON & THOMAS, PLLC, 625 SLATERS LANE, FOURTH FLOOR, ALEXANDRIA, VA, 22314

(21) Appl. No.: 10/148,885

(22) PCT Filed: Dec. 13, 2000
(86) PCT No.: PCT/KR00/01447

(30) Foreign Application Priority Data
Dec. 17, 1999 (KR) 1999/58500

(51) Int. Cl. H04B 7/00; H04Q 7/20

(52) U.S. Cl. 455/518; 455/519

(57) ABSTRACT

A multicall set-up and release method implements a multicall service in a next generation mobile communications system. If a multicall set-up is requested, the multicall is established in a signaling connection control part (SCCP) and infomation related to the multicall is stored in a call control table. On the other hand, if a multicall release is requested, the only call for which the call release is requested is released among calls in the multicall and a SCCP connection with a mobile station is maintained. However, if there exists only one established call in the multicall and the call release is requested for the call, not only the call is released but the SCCP connection is also disconnected with the mobile station.

### FIELD OF THE INVENTION

The present invention relates to a mobile communications system; and, more particularly, to a method for controlling a multicall in a next generation-mobile communications system.

### BACKGROUND OF THE INVENTION

A next veneration mobile communications system is to provide more diversified communications services than existing telecommunications systems, and one of those services is a multicall service. The multicall service refers to a communications service through which a certain mobile station can communicate with a plurality of mobile stations at the same time. Such multicall service is implemented by allotting, e.g., the certain mobile station to establish additional calls with other mobile stations after it has already established one call. Therefore, with the benefit of the multicall service, the certain mobile station is not only able to transceive data information through an Internet connection but also receive image data from a video on demand (VOD) server while communicating with another mobile station.

Up to now, however, just a concept and theory of such multicall service has been introduced but no practical technology capable of realizing the multicall service has been suggested. For instance, there is known no signal processing method for setting up and releasing the multicall.

### SUMMARY OF THE INVENTION

It is, therefore, an object of the present invention to provide a method for setting up and releasing a multicall so as to implement a multicall service in a next generation mobile communications system.

In accordance with one aspect of the present invention, there is provided a method for setting up a multicall of a mobile switch center (MSC) which receives and processes a multicall originating request provided from a radio network controller (RNC) in response to a multicall set-up request supplied from a mobile station, the method comprising the steps of:

storing information related to the multicall in a call control table when the multicall originating request is provided from the RNC;

storing information related to a call for which the multicall is requested in a call register;

allocating a resource between the RNC and the MSC;

providing the RNC with a call processing signal indicating that the requested call is being processed in response to the multicall set-up request;

storing information for the allocated resource in the call register; and

requesting to the RNC an allocation of a wireless resource between the RNC and the mobile station.

In accordance with another aspect of the present invention, there is provided a method for releasing a call of a mobile switch center (MSC) in a mobile communications network employing a call control table which contains information on is a master index master_idx, a call number call_no and a multicall flag multicall_flag, the method comprising the steps of:

determining whether a call release request is provided from a call originating end or a call terminating end;

if the call release request is supplied from the call originating end.

i) checking whether a multicall is established;

ii) withdrawing a resource allocated to a mobile station of the call originating end if the multicall is established;

iii) requesting the call terminating end to release the call; and

iv) updating the call control table in response to the call release; and

if the call release request is provided from the call terminating end,

v) checking whether the multicall is established;

vi) withdrawing a resource allocated to a mobile station of the call terminating end if the multicall is established;

vii) requesting the mobile station of the call originating end to release the call; and

viii) updating the call control table in response to the call release.

### BRIEF DESCRIPTION OF THE INVENTION

The above and other objects and features of the present invention will become apparent from the following description of preferred embodiments given in conjunction with the accompanying drawings, in which:

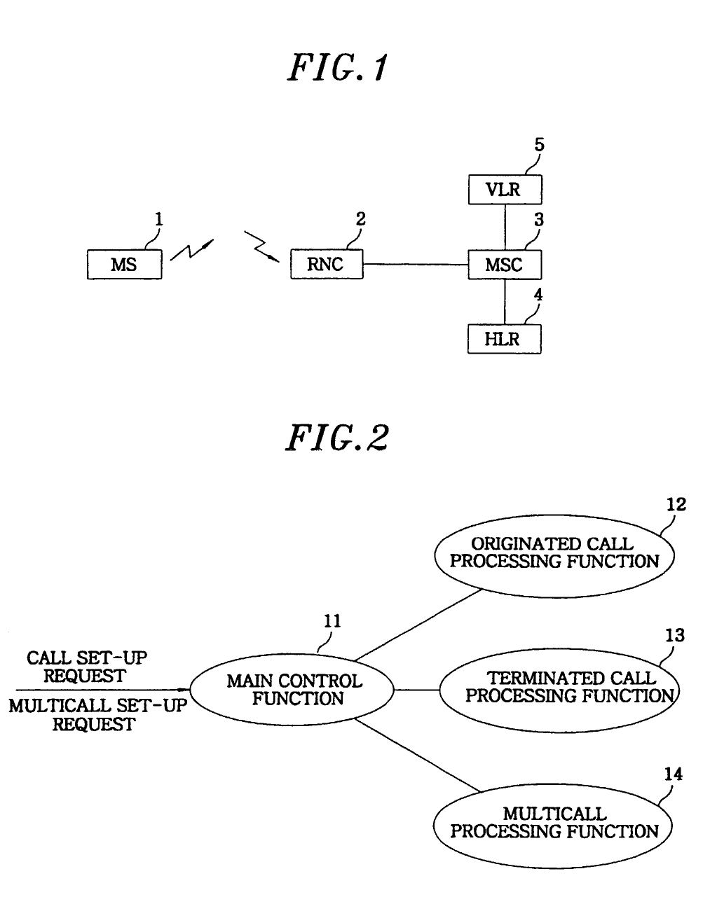

FIG. 1 is a schematic block diagram of a next generation mobile communications system that implements a method for setting up and releasing a multicall in accordance with the present invention;

FIG. 2 depicts a block diagram for illustrating a user signaling control function block in the next generation communications system in accordance with the present invention;

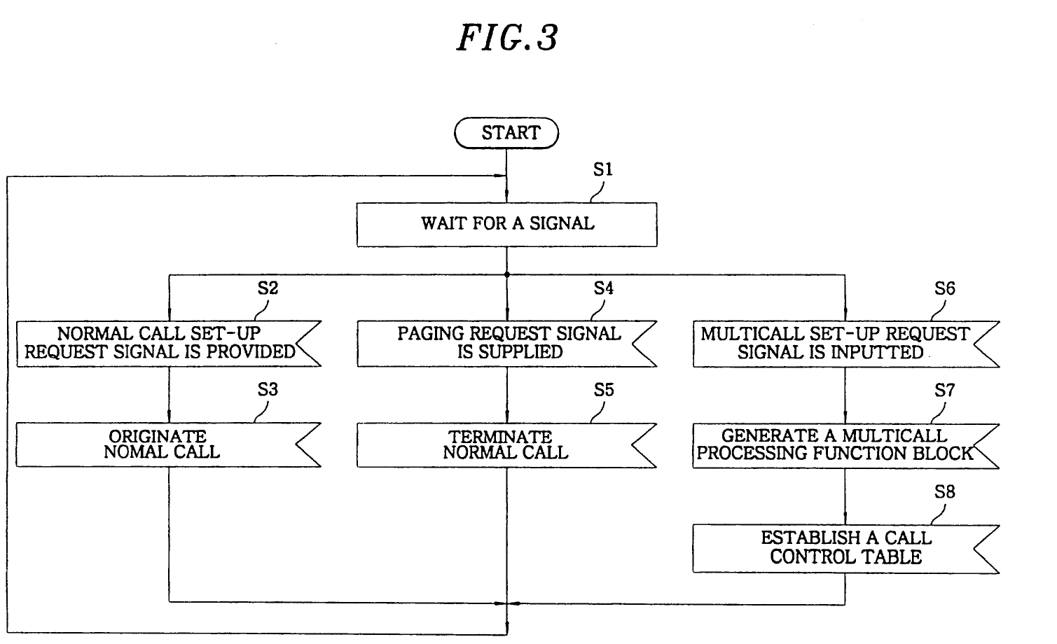

FIG. 3 presents a flow chart for showing a multicall set-up process in the next generation mobile communications system in accordance with the present invention;

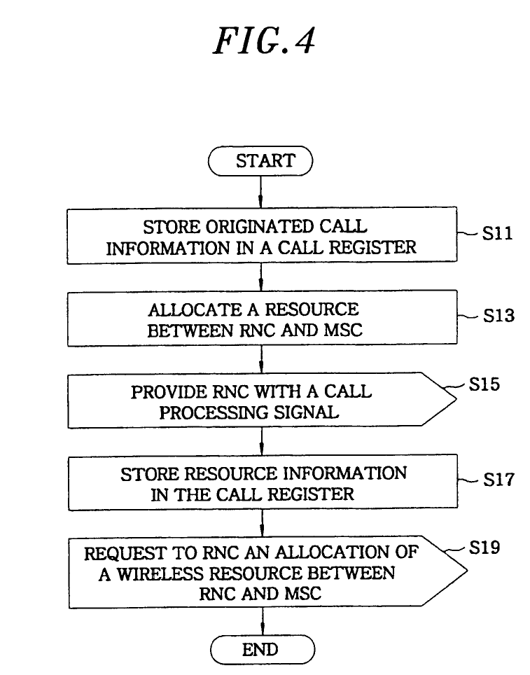

FIG. 4 provides a flow chart for describing an operation of a multicall processing function block performing the multicall set-up process in the next Generation mobile communications system in accordance with the present invention; and

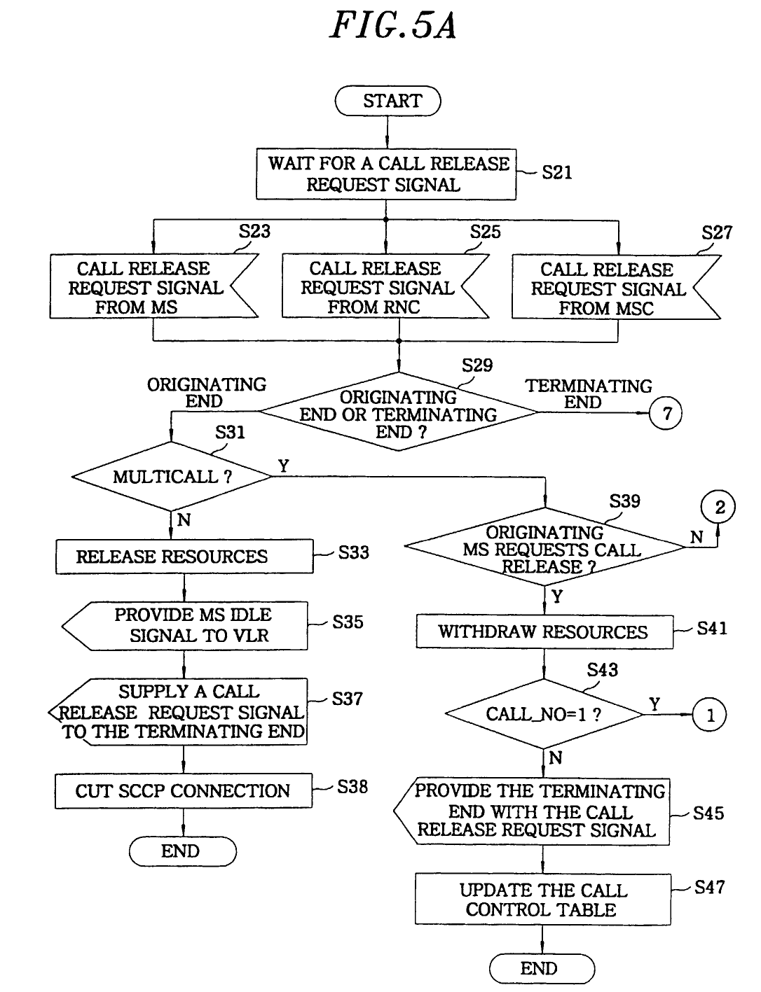

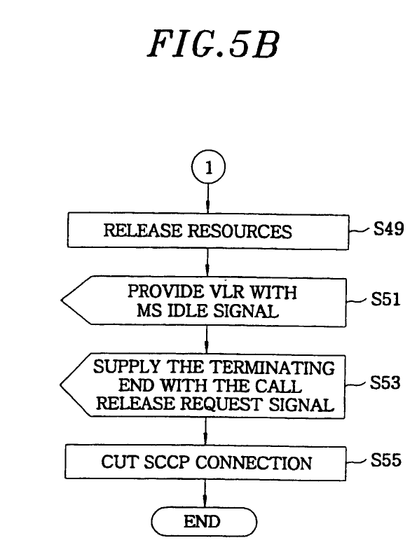

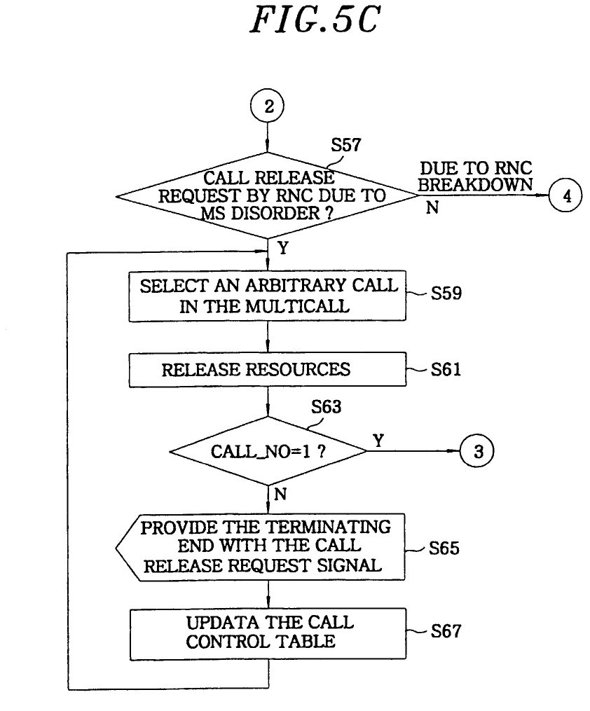

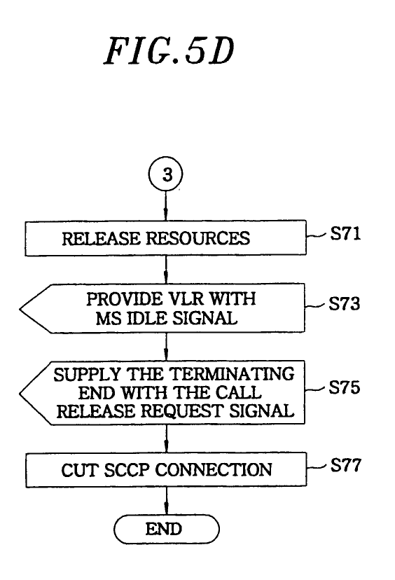

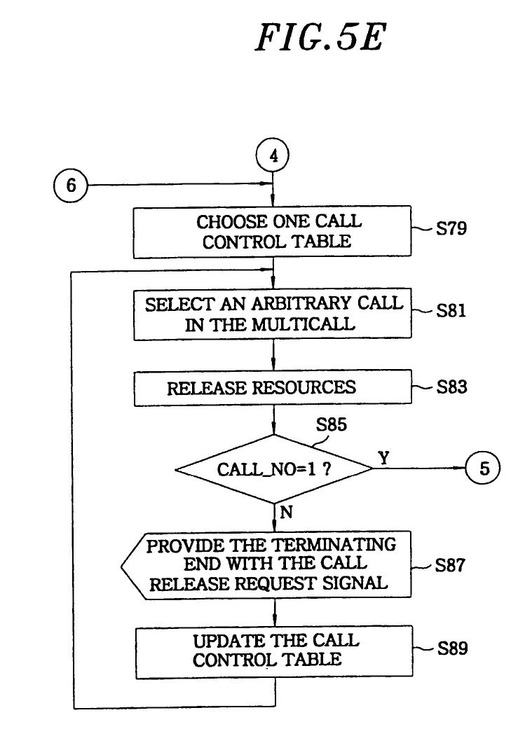

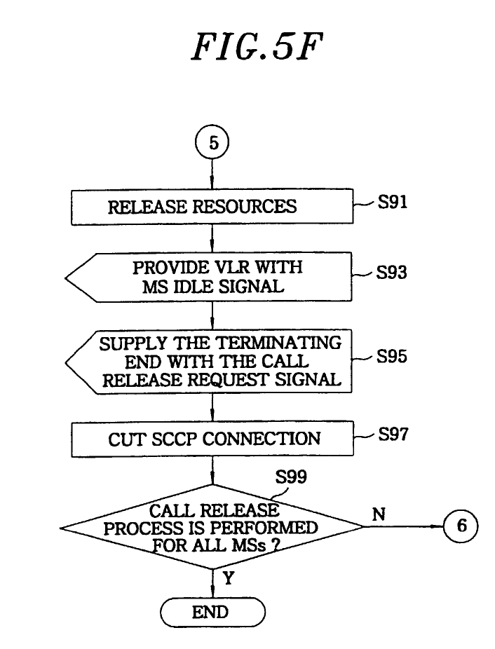

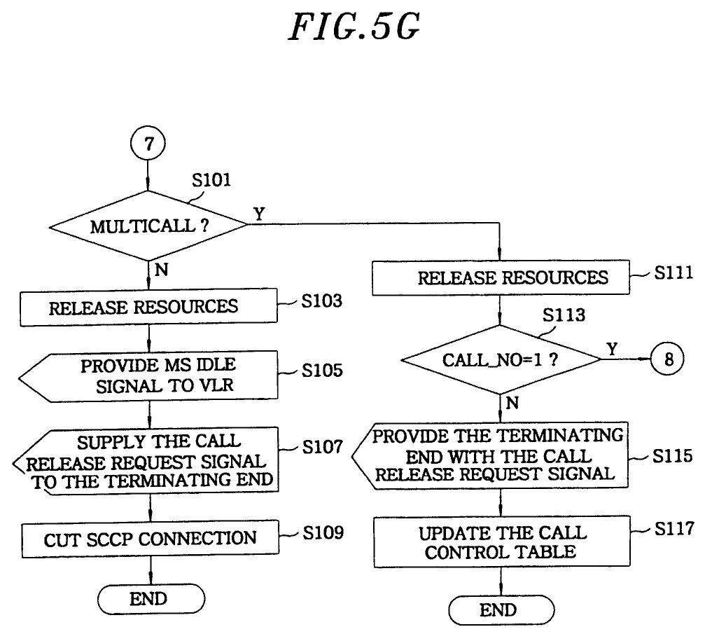

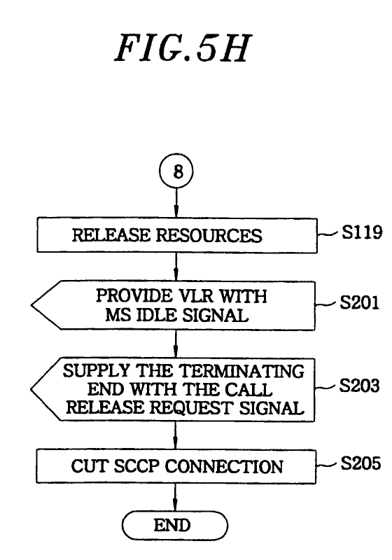

FIGS. 5A to 5H are flow charts for explaining a multicall release process in the next generation mobile communications system in accordance with the present invention.

### DESCRIPTION OF SPECIFIC EMBODIMENTS

The preferred embodiments of the present invention will now be described in detail with reference to the accompanying drawings.

FIG. 1 exemplifies a next generation mobile communications system in accordance with the present invention, wherein a subscriber can have wireless access to a network by using a mobile station (MS) (1). The mobile station (1) used herein should be able to serve a multicall in order to implement the present invention. Though there is shown only one mobile station in FIG. 1, a plurality of mobile stations can be wirelessly connected to the network.

The plurality of mobile stations are coupled to a radio network controller (RNC) (2), which relays communications signals between the mobile station (1) and a mobile switch center (MSC) (3). Further, a plurality of RNCs can be connected to the single MSC (3).

The MSC (3) is an automatic system for interfacing subscribers' communications from a wireless network to either a wired network or another wireless network.

A home location register (HLR) (4) stores subscriber information including, e.g., an electronic serial number, a user file and a current location so as to manage the mobile phone subscriber. The HLR (4) can be located combined with or independently of the MSC (3), and the single HLR (4) can provide its service to a plurality of MSCs (3).

A visited location register (VLR) (5) connected to one or more of MSCs (3) brings subscriber information corresponding to the mobile station (1) from the HLR (4) and stores the subscriber information therein when the mobile station (1) is located in an area covered by the VLR (5). When the mobile station (1) enters a new service area covered by the MSC (3), the MSC (3) extracts information on the mobile station (1) from the HLR (4) and stores the extracted information in the corresponding VLR (5).

In the next generation mobile communications system configured as shown in FIG. 1, the MSC (3) should have an IMT-2000 user signaling control function block illustrated in FIG. 2 in order to provide the multicall service.

As shown in FIG. 2, the user signaling control function block generates a main control function block (11), an originated call processing function block (12), a terminated call processing function block (13) and a multicall processing function block (14) during a call processing, to thereby process a requested call.

Meanwhile, there is an interfacing block between the RNC (2) and the MSC (3), wherein the interfacing block provides the MSC (3) with a call set-up request signal transmitted from the mobile station (1), and further provides the MSC (3) with a multicall set-up request signal in case the mobile station (1) requests a set-up of an additional call, i.e., a multicall. In response to the multicall set-up request signal, the user signaling control function block generates the multicall processing function block (14) to process the requested multicall.

The MSC (3) needs to form a call control table having information to be described hereinafter so that the multicall processing function block (14) can process the requested multicall.

The call control table should contain a local reference value local_ref, a call reference value call_ref, a master index master_idx, a call register number callreg_no, a call number call_no and a multicall flag multicall_flag.

The local_ref represents a connection distinguishing value of a signaling connection control part (referred to as a SCCP hereinafter), which the mobile station (1) can have for establishing a call. The call_ref refers to a value allocated to each call in the multicall to distinguish respective calls in the multicall.

The master_idx is a value assigned to an arbitrary call selected as a master call among the calls in the multicall and it is to be used for a call release.

The callreg_no offers address information of a call register which stores information related to the calls in the multicall, i.e. information required for a call maintenance and management such as MS numbers of mobile stations where the calls are originated and terminated. The call_no presents the number of calls constituting the multicall.

The multicall_flag is a flag indicating whether the current mobile station (1) establishes a multicall. For example, when the multicall_flag has a ‘set’ state, it denotes that the multicall is established for the mobile station (1), whereas when the multicall_flag is in a ‘reset’ state, it represents that the mobile station (1) sets up a normal call.

The multicall set-up and release processes of the MSC (3) in a next generation mobile communications system having the configuration as described above will be explained in detail hereinafter.

The multicall originating process will be explained with reference to FIG. 3 and FIG. 4.

More specifically, FIG. 3 illustrates the multicall originating process in the next generation mobile communications system in accordance with the present invention and FIG. 4 particularly describes an operation of the multicall processing function block (14) in performing the multicall originating process.

As shown in FIG. 3, in order to perform a call originating process, the MSC (3) waits for a signal transmitted from the mobile station (1) in step S1. Then, if a normal call set-up request signal is provided from the RNC (2) in step S2, the MSC (3) performs a normal call originating process in step S3 but, if a paging request signal is supplied from the RNC (2) in step S4, the MSC (3) executes a normal call terminating process in step S5. On the other hand, if a multicall set-up request signal is supplied from the RNC (2) in step S6, the MSC (3) carries out the multicall terminating process. Herein, the interfacing block between the RNC (2) and the MSC (3) provides the MSC (3) with the multicall set-up request signal when the mobile station (1) having a pre-established call requests an additional call.

The multicall originating process is initiated as the MSC (3) receives the multicall set-up request signal in step S6, and the main control function block (11) within the MSC (3) generates the multicall processing function block (14) in step S7 and, in response to the multicall set-up request signal, establishes information on the mobile station (1) within the call control table in step S8.

The information established in the call control table includes a call_ref, a master_idx, a callreg_no, a call_no and a multicall_flag of the additional call, i.e., the call newly established in the multicall, in addition to a local_ref of the pre-established call. Such information is used to distinguish the respective calls in the multicall and to release the established calls.

When steps S3, S5 and S8 are completed, the process returns to step S1 and the MSC (3) waits for a next signal to be provided from the mobile station (1) in step S1.

After step S7 is performed, as described in FIG. 4, the multicall processing function block (14) in the MSC (3) stores the information established in step S8, e.g., information on an originated call and a terminated call, in a corresponding call register in step S11, and allocates a bandwidth (resource) between the RNC (2) and the MSC (3) to thereby form a communications channel therebetween in step S13. Afterwards, in response to a multicall process request signal provided from the RNC (2), in step S15, the multicall processing function block (14) provides the RNC (2) with a call processing signal indicating that the requested call is being processed and, in step S17, stores information on the bandwidth allocated in step S13 in the call register.

Then, the multicall processing function block (14) requests to the RNC (2) an allocation of a wireless resource, i.e., a wireless bandwidth between the RNC (2) and the MSC (3) in step S19, and, thereafter, this multicall originating process is terminated.

As can be seen from the above description, a plurality of calls are established in the SCCP corresponding to the single mobile station (1), and a bandwidth and a unique call reference value call_ref are allocated to each of the calls in the multicall, wherein the number of a register that stores information about each of the calls is determined as a call register number.

It is well known to those skilled in the art that the call set-up process or terminating process for the respective calls in the multicall, as explained above, is the same as that for a normal call. The call release process for the calls in the multicall, however, is not same as that required for the normal call. Thus, the call release process of the multicall (to be referred to as the multicall release process) will be described hereinafter.

The multicall release process can be classified into three modes: a first mode for releasing the calls in the multicall in response to a request of an originating mobile station, a second mode responding to a request of the RNC (2), and a third mode responding to a request of the MSC (3). Herein, the first and the second call release mode responding to the requests of the originating mobile station and the RNC (2) are performed in response to a request of an originating end from the standpoint of the multicall processing function block (14). On the other hand, the third call release mode responding to the request of the MSC (3) is executed in response to a request of a terminating end, i.e., a terminating mobile station. Accordingly, the multicall release process can also be classified into two modes, one of which is performed in response to the request of the originating end and the other is executed by the request of the terminating end.

Now, the multicall release process will be explained by classifying the process into an originating end request mode and a terminating end request mode as described in FIGS. 5A to 5H.

As illustrated in FIG. 5A, the multicall processing function block (14) in the MSC (3) waits for a call release request signal to be inputted thereto in step S21, and receives the call release request signal transmitted from the originating mobile station in step S23, from the RNC (2) in step S25, or from the MSC (3) in step S27. Since the multicall release process can be classified into the originating end request mode and the terminating end request mode as explained above, the multicall processing function block (14) checks whether the inputted call release request signal is provided from the call originating end or the call terminating end in step S29.

As a checking result of step S29, if it is found that the call release request signal is provided from the call originating end, i.e., the originating mobile station or the RNC (2), the multicall processing function block (14) checks whether or not the multicall_flag has a ‘set’ state, i.e. whether a current call is a multicall or a normal call in step S31.

If it is judged in step S31 that the current call corresponding to the call release request signal is a normal call, the multicall processing function block (14) releases resources assigned to a corresponding originating mobile station in step S33 and, in step S35, provides the VLR (5) with an MS idle signal so as to report that the call of the originating mobile station is released. Then, in step S37, the multicall processing function block (14) supplies a call release signal to the terminating end to request a call release and cuts the SCCP connection with the corresponding originating mobile station in step S38, so that the call release process is completed.

Unlike the case of the normal call described above, several additional steps are required for processing the multicall. This is because even though one call in the multicall is released, the originating mobile station has to sustain the other calls in the multicall. In other words, it has to release only the call for which the call release is requested, not the others. Accordingly, as for the multicall, neither the MS idle signal is offered to the VLR (5) nor the SCCP connection with the originating mobile station is cut in the case when only one call in the multicall is released. The call release process for the multicall will be described in detail hereinafter.

If the current call corresponding to the call release request signal is determined as the multicall in step S31, the multicall processing function block (14) then checks whether the call release request signal is originated from the originating mobile-station in step S39.

When it is judged that the call release request signal is provided from the originating mobile station (1), in step S41, the multicall processing function block (14) withdraws resources allocated to the call for which the call release is requested and checks whether the number of calls call_no stored in the call control table is 1 in step S43. When the call_no is 1, it represents that the number of ongoing calls in the multicall is 1. On the other hand, when the call_no is larger than 1, it means that the originating mobile station (1) is forming a plurality of calls.

Therefore, if the call_no is larger than 1, the multicall processing function block (14) releases the call for which the call release is requested by requesting the terminating end to release the corresponding call in step S45, and updates the call control table by reducing the call_no by 1 in step S47. In case the call subject to the call release has the master_idx, another call is selected as a master call and a new master_idx is established and stored in the call control table.

As explained above, when the call_no is larger than 1, the multicall processing function block (14) neither provides the VLR (5) with the MS idle signal nor cuts the SCCP connection, so that the originating mobile station can support continuous communications for the other calls in the multicall.

On the other hand, if the call_no is 1, since there exists only one ongoing call though the multicall is established, the communications with the originating mobile station should be terminated. Accordingly, the multicall processing function block (14) proceeds to step S49 to release resources for the originating mobile station and, in step S51, provides the VLR (5) with the MS idle signal in order to report that the call of the originating mobile station is released. Then, the multicall processing function block (14) provides the terminating end with the call release request signal to release the corresponding call in step S53 and the SCCP connection with the corresponding originating mobile station is cut in step S55, so that the multicall release process is completed.

As illustrated in FIGS. 5A and 5B, steps S41 to S55 show the call release process requested by the originating mobile station. Such call release process requested by the RNC (2) can be classified into two cases again. One is a case where all calls in a multicall of a mobile station connected to the RNC (2) need to be released because some disorders occur in the mobile station. The other is a case where all calls of mobile stations connected to the RNC (2) should be released because of a breakdown of the RNC (2) itself.

The RNC (2) provides the MSC (3) with information representing the reason why the call release is requested, i.e., whether the call release request is caused due to the disorder of the mobile station or by the breakdown of the RNC (2) itself. Therefore, the multicall processing function block (14) operates in one of the two modes based on such information.

As shown in FIG. 5C when it is determined in step S57 that the call release is requested by the RNC (2) because of the disorder of the mobile station, the call release process proceeds to step S59.

In step 59, the multicall processing function block (14) selects an arbitrary call_ref in the call control table related to the multicall of the mobile station having some disorders and clears the call establishment of the selected call by performing steps S61 to S77 as described in FIGS. 5C and 5D. The detailed description of steps S61 to S77 is omitted herein because it is the same as that of steps S39 to S55 described above in conjunction with FIGS. 5A and 5B. It needs to be pointed out, however, that in the above steps S61 to S77 when step S67 is completed, the multicall processing function block (14) returns to step S59 and repeatedly performs steps S59 to S67 until the multicall release process is performed for all of the calls registered in the call control table.

In step S63, the multicall processing function block (14) selects the number of calls call_no within the call control table in this preferred embodiment. However, a master_idx can be used, if necessary, on behalf of the call_no. That is, it is already known to those skilled in the art that whether the call_no is 1 or not can be determined by checking whether there is no more call_ref to which the master_idx can be allocated in step S63, i.e., whether there is no more call in the multicall to which the master_idx can be allocated since a new call can be assigned to have the master_idx in step S67 in case the call corresponding to the master_idx is released.

On the other hand, when it is judged that in step S57 the call release is requested by the RNC (2) because of some problems of the RNC (2) itself, the multicall processing function block (14) performs steps S79 to S99. This call release process is the same as that required for the call release requested by the RNC (2) because of the disorders of the mobile station, except for the fact that it further includes steps S79 and S99 as shown in FIGS. 5E and 5F. To be specific, in step S79, one call control table is chosen among a plurality of call control tables of mobile stations connected to the RNC (2), i.e. mobile stations whose calls are established through the RNC (2), and the mobile station corresponding to the selected call control table is chosen. Steps S81 to S97 are performed for the selected mobile station to carry out the multicall release process. Then in step S99, it is checked whether the multicall release process is performed for all of the mobile stations corrected to the RNC (2) and if it is found as such, the multicall release process is terminated.

Herein below, the call release process is described for the case where the call release request signal is provided from the call terminating end, i.e. the MSC (3).

If the call release request signal is transmitted from the call terminating end, the multicall processing function block (14) decides whether the multicall_flag is in a ‘set’ state or not in step S101. In other words, the multicall processing function block (14) determines whether a current call is a multicall or a normal call.

As a result of the decision at step S101, if it is found that the current call for which the call release is requested is the normal call, the multicall processing function block (14) proceeds to step S103 to clear resources allocated to a mobile station corresponding to the current call, and reports the call of the originating mobile station is released by providing the VLR (5) with an MS idle signal in step S105. Thereafter, the call release signal is provided to the originating mobile station to request the call release in step S107 and the SCCP connection with the originating mobile station is cleared, thereby completing all the process for the call release in step S109.

However, as a result of the decision at step S101, if it is found that the current call is the multicall, the multicall processing function block (14) withdraws the resources allocated to the call subject to the call release in step S111 and checks whether the number of calls stored in the call control table call_no is 1 in step S113. If the call_no is larger than 1, the multicall processing function block (14) performs the call release for the corresponding call by requesting the mobile station to clear the corresponding call in step S115 and updates the internal call control table by reducing the call_no by 1 in step S117.

On the other hand, if the call_no is 1, the call of the originating mobile station should be cleared since there is only one ongoing call though the current call is the multicall. Accordingly, the multicall processing function block (14) clears the resources allocated to a corresponding terminating mobile station in step S119 and provides the VLR (5) with the MS idle signal to report the call of the terminating mobile station is released in step S201. Thereafter, the call release request signal is provided to the originating mobile station to request the call release in step S203, and the SCCP connection with the originating mobile station is cut in step S205, so that the whole process for releasing the call is completed.

As described above, the present invention provides a practical signal processing method for setting up and releasing a multicall so that the multicall service can be realized in the next generation mobile communications systems.

While the invention has been shown and described with respect to the preferred embodiments, it will be understood by those skilled in the art that various changes and modifications may be made without departing from the scope of the invention as defined in the following claims.

1. A method for setting up a multicall of a mobile switch center (MSC) which receives and processes a multicall originating request provided from a radio network controller (RNC) in response to a multicall set-up request supplied from a mobile station, the method comprising the steps of:
storing information related to the multicall in a call control table when the multicall originating request is provided from the RNC;
storing information related to a call for which the multicall is requested in a call register;
allocating a resource between the RNC and the MSC;
providing the RNC with a call processing signal indicating that the requested call is being processed in response to the multicall set-up request;
storing information on the allocated resource in the call register; and
requesting to the RNC an allocation of a wireless resource between the RNC and the mobile station.

2. The method of claim 1, wherein the information stored in the call control table includes:
a local reference value local_ref that represents a connection distinguishing value of a signaling connection control part (SCCP) that one mobile station is able to have for a call set-up;
a call reference value call_ref allocated to each call in the multicall so as to distinguish respective calls therein;
a master index master_idx allocated to a call selected as a master call among the calls in the multicall;
a call register number callreg_no that offers address information of a call register which stores information related to each of the calls in the multicall;
a call number call_no which presents the number of calls constituting the multicall; and
a multicall flag multicall_flag that indicates whether the multicall is established.

3. A method for releasing a call of a mobile switch center (MSC) in a mobile communications network employing a call control table which contains information on a master index master_idx, a call number call_no and a multicall flag multicall_flag, the method comprising the steps of:
determining whether a call release request is provided from a call originating end or a call terminating end;
if the call release request is supplied from the call originating end,
i) checking whether a multicall is established;
ii) withdrawing a resource allocated to a mobile station of the call originating end if the multicall is established;
iii) requesting the call terminating end to release the call; and
iv) updating the call control table in response to the call release; and
if the call release request is provided from the call terminating end,
v) checking whether the multicall is established;
vi) withdrawing a resource allocated to a mobile station of the call terminating end if the multicall is established;
vii) requesting the mobile station of the call originating end to release the call; and
viii) updating the call control table in response to the call release.

4. The method as recited in claim 3, wherein a decision about whether the multicall is established is made based on whether the multicall flag is in a ‘set’ state or in a ‘reset’ state.

5. The method as recited in claim 3, after the steps ii) and vi), further comprising the steps of:
determining whether the number of calls set up in the multicall is 1 or not based on the call_no;
reporting to a home location register (VLR) of the call release if the number of calls set up in the multicall is 1;
requesting the mobile station of the originating end and the terminating end to release the call; and
cutting a connection between a signaling connection control part (SCCP) and the mobile station establishing the multicall.

6. The method as recited in claim 3 further comprising the steps of:
setting up one of the calls in the multicall as a master call, determining one of the remaining calls in the multicall as a new master call if the master call is released and allocating the master_idx to the new master call;
determining whether a call to be decided as the master call exists in the multicall in order to decide whether the number of calls set up in the multicall is 1 after performing the steps ii) and vi);
reporting to the VLR of the call release if the number of calls set up in the multicall is 1;
requesting the mobile station of the originating end and the terminating end to release the call; and
cutting the connection between the SCCP and the mobile station establishing the multicall.

7. The method as recited in claim 5 or 6 further comprising the steps of:
determining whether the call release is requested by a radio network controller (RNC) because of some disorders of the mobile station of the originating end; and
performing the steps i) to iv) for all the calls in the multicall which are communicating with the mobile station of the originating end if the call release request is originated due to the disorders of the mobile station of the originating end.

8. The method as recited in claim 5 or 6 further comprising the steps of:
determining whether the call release is requested by the RNC because of a breakdown of the RNC; and
performing the steps i) to iv) for all mobile stations whose calls are connected to the RNC if the call release request is originated due to the breakdown of the RNC.
